(19) United States
(12) Patent Application Publication
(10) Pub. No.: US 2005/0223176 A1
(43) Pub. Date: Oct. 6, 2005

(54) Sensory ego-sphere: a mediating interface between sensors and cognition

(76) Inventor: Richard Alan Peters II, Nashville, TN (US)

Correspondence Address: MORGAN, LEWIS & BOCKIUS LLP, 1111 PENNSYLVANIA AVENUE, WASHINGTON, DC, 20004, US

(21) Appl. No.: 11/025,768

(22) Filed: Dec. 30, 2004

Related U.S. Application Data
(60) Provisional application No. 60/533,863, filed on Dec. 30, 2003.

(51) Int. Cl. G06F 12/00

(52) U.S. Cl. 711/141

(57) ABSTRACT

A Sensory Ego-Sphere (SES) is an interface for a robot that serves to mediate information between sensors and cognition. The SES can be visualized as a sphere centered on the coordinate frame of the robot, spatially indexed by polar and azimuthal angles. Internally, the SES is a graph with a fixed number of edges that partitions surrounding space and contains localized sensor information from the robot.

### CROSS-REFERENCE TO RELATED APPLICATIONS

This application claims the priority to provisional application Ser. No. 60/533,863, filed Dec. 30, 2003. The entire contents of the above-referenced provisional application are incorporated herein by reference.

### STATEMENT REGARDING FEDERALLY SPONSORED RESEARCH OR DEVELOPMENT

The U.S. Government has a paid-up license in this invention and the right in limited circumstances to require the patent owner to license others on reasonable terms as provided for by the terms of the SFFP, GSRP, and RICIS programs awarded by NASA and the MARS program awarded by DARPA.

### BACKGROUND OF THE INVENTION

Today's robots can be equipped with a wide and powerful array of sensing modalities, but their cognitive abilities are still primitive. Coordinating input from the sensors presents significant challenges for robot cognition, and can even be confusing to a human supervisor or teleoperator.

### SUMMARY OF THE INVENTION

A mediating interface, called the Sensory Ego-Sphere (SES), that serves to coordinate sensory information for cognitive processing is described. The SES serves as an attentional, associative, short-term memory in the robot's control system. It operates asynchronously as a high-level agent in a parallel, distributed, object-oriented or agent-based, control system that includes independent, parallel sensory processing modules (SPMs).

### BRIEF DESCRIPTION OF THE DRAWINGS

The invention will be described by reference to the preferred and alternative embodiments thereof in conjunction with the drawings in which:

FIG. 1 is a diagram illustrating a geodesic dome representation of the SES in an embodiment of the present invention;

FIG. 2 is a diagram illustrating a relation between the geodesic dome representation of the SES and an underlying data structure in an embodiment of the present invention;

FIG. 3 is a diagram illustrating a base frame used by a robot in an embodiment of the present invention;

FIG. 4 is a diagram illustrating an end effector's trajectory in an embodiment of the present invention;

FIG. 5 is a diagram illustrating a base frame at two time instants for a robot in an embodiment of the present invention;

FIG. 6 is a diagram illustrating vector planes for the configuration shown in FIG. 5;

FIG. 7 is a diagram illustrating vectors used in another configuration in an embodiment of the present invention;

FIG. 8 is a diagram illustrating additional vector quantities for the configuration shown in FIG. 7; and

FIG. 9 is a diagram illustrating another vector representation of the configuration shown in FIG. 7.

### DETAILED DESCRIPTION

For a person interacting with the robot, either through teleoperation or as a supervisor, the SES can be visualized as a spherical shell centered on the robot's base frame. Each point on the shell is a locally connected memory unit with an associated activation vector and a temporal decay. From an internal, computational point of view, the SES is a graph whose edges form a geodesic tessellation of a sphere. Each node of the graph connects to a database in addition to its neighbors. An SES manager program interacts with other agents to write and read information to the SES.

On the sensory side of the SES, SPMs attach data (write) to points on the sphere. Directional sensors write data to the SES at the point in the direction of the data source. Such sensors may be exteroceptive, e.g., vision, SONAR, LIDAR, IR, or proprioceptive, e.g., joint angles, force, torque. Non-directional sensors, e.g., battery level, write to an additional point included for such data. When an SPM writes to a point on the SES, the data is stored at the node closest to that point. The actual direction, distance (if known), and time (adjusted for the known latency of the SPM) are recorded and the value of an element in an associated activation vector is increased in a neighborhood of the point. (Although the data structure is discrete and of possibly lower resolution than some of the SPMs that write to it, full location resolution is maintained because that information is written along with the rest of the data. The geodesic discretization permits fast searches through the database, indexed by location.) The activation level decays with a time constant that is a function of the data type. Agents that use sensory data may read from the SES or may add activation to points of interest. Object recognizers or manipulation routines can place object descriptors on the SES or search for them there.

This operation in itself makes the SES useful for people interacting with a robot as it provides an ego-centric representation of the robot's knowledge of the current environment. Additionally though, the SES possesses affordances that allow the cognitive mechanisms of a robot to leverage and coordinate sensor data easily. The SES and results for a number of tasks that have been implemented on humanoid robots (ISAC at Vanderbilt, and Robonaut at NASA) and mobile robots at Vanderbilt are described. See, for example, K. Kawamura, R. A. Peters II, D. M. Wilkes, W. A. Alford, and T. E. Rogers, “Isac: foundations of human-humanoid interaction,” IEEE Intelligent Systems, vol. 15, no. 4, pp. 38-45, July 2000, R. O. Ambrose, H. Aldridge, R. S. Askew, R. R. Burridge, W. Bluethmann, M. Diftler, C. Lovchik, D. Magruder, and F. Rehnmark, “Robonaut: Nasa's space humanoid,” IEEE Intelligent Systems, vol. 15, no. 4, pp. 57-63, July 2000, and K. Kawamura, A. B. Koku, D. M. Wilkes, R. A. Peters II, and A. Sekmen, “Toward egocentric navigation,” International Journal of Robotics and Automation, vol. 17, no. 4, pp. 135-145, October 2002. In particular, we describe the SES in the following roles:
1) As a short-term memory for the cognitive functions the robot.
2) Associating sensory and motor data via spatio-temporal coincidence.
3) For directing the attention of the robot.
4) For spatial localization of the robot with respect to known landmarks and navigation.

The concept of an ego-sphere for a robot was first proposed by Albus, as described in J. S. Albus, “Outline for a theory of intelligence,” IEEE Transactions on Systems, Man, and Cybernetics, vol. 21, no. 3, pp. 473-509, May 1991. He envisioned it as a dense map of the world, a shell surrounding the robot onto which a sensory snapshot of the world is projected. He proposed that a robot use a concentric set of ego-spheres, one for each directional sensor. Our definition and use of it differ somewhat. For example, ours is not a dense map and we use only one structure for all the sensors. Thus, we add the word “sensory” to distinguish it from Albus' original definition.

Our description of the SES as a mediating interface between sensors and cognition is motivated by several theories of the function of hippocampus in mammals, particularly Marr's theory of the function of the hippocampus as an associative memory. See, for example, D. Marr, “Simple memory: a theory for archicortex,” Philosophical Transactions of the Royal Society of London, B, vol. 262, pp. 23-81, 1971. While these theories of hippocampal function are controversial, Recce and Harris, in M. M. Recce and K. D. Harris, “Memory for places: a navigational model in support of marr's theory of hippocampal function,” Hippocampus, vol. 6, pp. 735-748, 1996, have implemented a model consistent with this theory on a mobile robot that is able to navigate and find a hidden goal. Like our implementation of the SES, their representation of space is ego-centric. The SES does not incorporate any of their models into its function, but generalizes this function into a computationally efficient structure.

The idea of coordinating between sensors and cognition has been explored in the robotics community. Conceptually, this work is similar to the work of Brill et al. described in F. Z. Brill, W. N. Martin, and T. J. Olson, “Markers elucidated and applied in local 3-space,” in Proceedings of the 1995 IEEE Symposium on Computer Vision, 1995, pp. 49-54, who developed an ego-centric marker-based system for reactive planning and vision in dynamic 3D environments. The main difference between their work and ours is the lack of a specific coincidence detection mechanism in the former work. Soyer et al., in C. Soyer, H. I. Bozma, and Y. Istefanopulos, “A new memory model for selective perception systems,” in Proceedings of IEEE/RSJ International Conference on Robots and Systems, Japan, October 2000, describe a similar mechanism for perception systems. Their “bubble” representation is not ego-centric and can deform, thus losing some of the spatio-temporal properties of the SES. Wasson et al. describe in G. Wasson, D. Kortenkamp, and E. Huber, “Integrating active perception with an autonomous robot architecture,” in Proceedings of the 2nd International Conference on Autonomous Agents (Agents'98), K. P. Sycara and M. Wooldridge, Eds. New York: ACM Press, September 1998, pp. 325-331, an integrated agent architecture that incorporates perception. Finally, Choi and Chen, in B. Choi and Y. Chen, “Humanoid motion description language,” in Second International Workshop on Epigenetic Robotics, 2002, pp. 21-24, describe a descriptive language that encompasses many of the same features as the SES. We are currently exploring whether their work and ours can be integrated into a functioning unit to assist the cognitive capabilities of the robot. In general, these systems lack the affordances created by the spherical structure of the SES that allow for easier interaction with humans and efficient use of motion transformations for navigation and coincidence detection.

The authors are not aware of other computational structures for robots that provide a single interface for the four functions listed above. However, the individual functions have been much studied. For example, the references in the previous paragraph are closest to our own use of short-term memory; see D. L. Hall and J. Linas, Handbook of Multisensor Data Fusion. CRC Press, May 2001, and P. R. Cohen and N. Adams, “An algorithm for segmenting categorical time series into meaningful episodes,” in Proceedings of the Fourth Symposium on Intelligent Data Analysis, vol. 2189, 2001, pp. 198-207 for sensory-motor association; see B. Scassellati, “Imitation and mechanisms of joint attention: a developmental structure for building social skills on a humanoid robot,” in Computation for Metaphors, Analogy and Agents, ser. Springer Lecture Notes in Artificial Intelligence, C. Nehaniv, Ed. Springer-Verlag, 1998, vol. 1562, and S. Lang, M. Kleinehagenbrock, S. Hohenner, J. Fritsch, G. A. Fink, and G. Sagerer, “Providing the basis for human-robot-interaction: a multi-modal attention system for a mobile robot,” in Proceedings of International Conference on Multimodal Interfaces, November 2003 for attention; and see O. Trullier, S. Wiener, A. Berthoz, and J. Meyer, “Biologically-based artificial navigation systems: Review and prospects,” Progress in Neurobiology, vol. 51, pp. 483-544, 1997, and M. M. Matarić, “Integration of representation into goal-driven behavior-based robots,” IEEE Transactions on Robotics and Automation, vol. 8, no. 3, pp. 304-312, June 1992 for navigation. In particular, the navigation algorithm described below makes use of similar ideas. Additionally, the SES is not a complete solution to the problem of navigation since the use of an ego-centric representation alone has some disadvantages—see, for example, S. Thrun, “Robotic mapping: a survey,” in Exploring Artificial Intelligence in the New Millenium, G. Lakemeyer and B. Nebel, Eds. Morgan Kaufmann, 2002.

Overview of the Sensory Ego-Sphere

There are two primary hypotheses behind our definition and use of the SES: (1) often, a physical event in the environment will stimulate more than one of the robot's sensors, and (2) changes in motion of the robot will precipitate sensor events. By an event, we mean a sudden detectable change in the signal, its derivatives, or its statistics. Thus, if two or more of the SPMs detect events at nearly the same time, and if directionally sensitive modules report their events as having emanated from similar directions in space, then we presume that the robot has detected a real event. Moreover, if a change in motion is accompanied by the registration of events by more than one sensor we presume the events may be relevant. By including proprioceptive sensing and motor control sequences with the exteroceptive sensory streams that project to it, the SES makes spatio-temporal sensory-motor data associations. It does so without having to perform any comparative operations on the sensory signals.

The SES can be defined mathematically as the set of radial distances from a designated point on the robot to the first encountered object points in space. That definition is simple but incomplete. This purely geometric definition implies that the structure is memoryless, whereas in fact it can be used as a memory structure. Much more than the distance to the first object in space is stored on the SES.

In its implementation on a robot, the SES is a database with associated computational routines. It is a sparse map of the world that contains pointers to sensory data or descriptors of objects or events that have been detected recently by the robot. Given that the sensors on a robot are discrete, there is nothing to gain by defining the SES to be a continuous structure. Moreover, the computational complexity of using the SES increases with its size which is, in turn, dependent on its density (number of points on its surface). The database's graphic connectivity is isomorphic to a regular, triangular tessellation of a sphere centered on the coordinate frame of the robot.

Geodesic Dome Topology

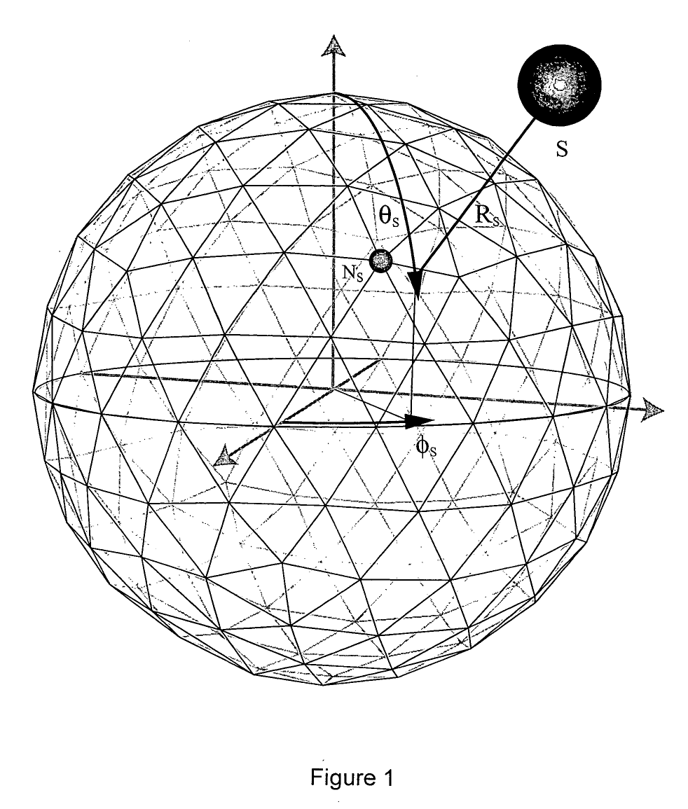

We define the topological structure of data connectivity in the SES to be that of a geodesic dome, shown in FIG. 1, since it is a quasi-uniform triangular tessellation of a sphere into a polyhedron. See A. C. Edmondson, A Fuller Explanation: the Synergetic Geometry of R. Buckminster Fuller. Boston: Birkhauser Verlag, January 1987, and K. Urner, “The invention behind the inventions: synergetics in the 1990's,” The Synergetica Journal, vol. 1, no. 1, 1991. It is “the optimal solution to the problem of how to cover a sphere with the least number of partially overlapping circles of the same radius.” See I. Stewart, “Circularly covering clatharin,” Nature, vol. 351, p. 103, May 1991. The triangles connect at vertices forming 12 pentagons and a variable number of hexagons. The pentagons are evenly distributed so that the node at the center of one is connected to the centers of five others by N vertices, where N is called the frequency of the dome. The number of vertices in the tessellation as a function of the frequency N is
V=10N²+2 (1)

We have found that a frequency of N=14 to be a useful tessellation, giving the SES 1950 hexagonally connected vertices and 12 pentagonally connected ones. That yields a spacing of about 4 to 5 degrees between adjacent vertices.

Two questions naturally arise. First, why not use a fully 3-D representation like an occupancy grid as described in, for example, S. Thrun, “Learning metric-topological maps for indoor mobile robot navigation,” Artificial Intelligence, vol. 99, no. 3, pp. 27-71, 1998? Second, why use a fixed tessellation?

From the robot's point of view, it is stationary while the world moves. Features of the environment are located in various directions, at various depths. Only directional information is needed to place features within the robot's locale. Knowledge of depth is needed only for specific interaction with an object. Hence we defined the mapping of the world to the SES not as explicitly 3-dimensional but as 2½-D in the sense of Marr and Hildreth as described in D. Marr and E. Hildreth, “Theory of edge detection,” Proceedings of the Royal Society of London, B, vol. 207, pp. 187-217, 1980; that is, the spatial distance to a point in the world is stored at a corresponding point (indexed by polar and azimuthal angles) on the SES. This representation maintains direction but computes depth as only needed. We believe this representation is more efficient than filling an occupancy grid with data whose distance may not be needed. The fixed size of the tessellation provides a fixed number of entry points into the sensory-motor database. The SES manager maintains a direct mapping between directions with respect to the robot and SES nodes. Only that mapping must be updated with motion of the robot. The data itself does not require modification until it is accessed, at which time an estimate of its current location can be updated. The search for a specific object or sensory feature in the worst case requires the traversal of only a fixed number of nodes.

Data Structure

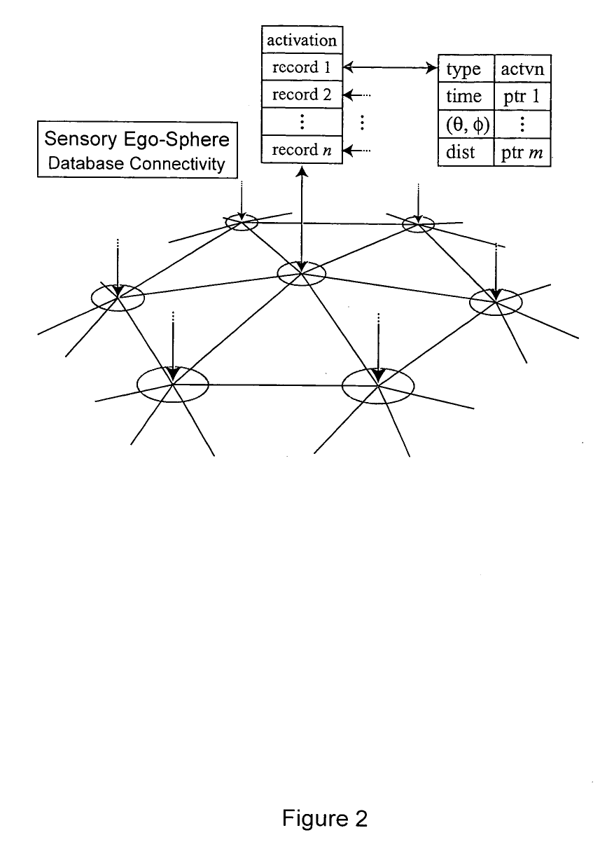

The geodesic dome topology of the SES organizes sensory and motor data with respect to a locally connected graph of pointers to data structures, indexed by location. Data from a directional SPM is stored at the node that is closest to the direction from which the stimulus arrived. One pointer exists for each vertex on the dome. Each pointer has six or seven links, one to each of its five or six nearest neighbors and one to a tagged-format data structure. The latter comprises a terminated list of alphanumeric tags each followed by a spatial location, a time stamp, an activation level, and another pointer. The fixed size, local connectivity, and directional indexing simplifies both the storage of sensory-motor data and ego-centric searches for it (see FIG. 2).

The tags describe the data modality, a description of the data, the data's full-resolution spatial location and the name of the feature or object that the data represents. The spatial location is the estimated direction of the data source or object and, if available, the distance to it. A time stamp designates when the data was registered onto the SES. The activation indicates the relative importance of the specific data. The pointer associated with the tag holds the location of a structure that contains (or points to) the sensory data. The number of tags and their types on any vertex of the dome are completely variable. A central node, connected to all of the others from the center of the sphere, monitors the time sequence of sensory and motor inputs to enable temporal association of spatially distributed events or non-directional events. The node also contains tags to the data, associated time stamps and activations of non-directional sensory data.

Sensory processing modules write information to the SES through a software object, the SES manager, which in turn interfaces to a standard database such as MySQL. See, for example, R. J. Yarger, G. Reese, and T. King, MySQL and mSQL. O'Reilly and Associates, August 1999. The manager can also perform a breadth-first search of the SES for the vertices that contain a given tag. The software object requesting the search can specify various search parameters such as the starting location, number of vertices to return, search depth, etc. The fixed number of nodes keeps the search paths fixed as the amount of data on the sphere increases.

Motion Transformations of the Sensory Ego-Sphere

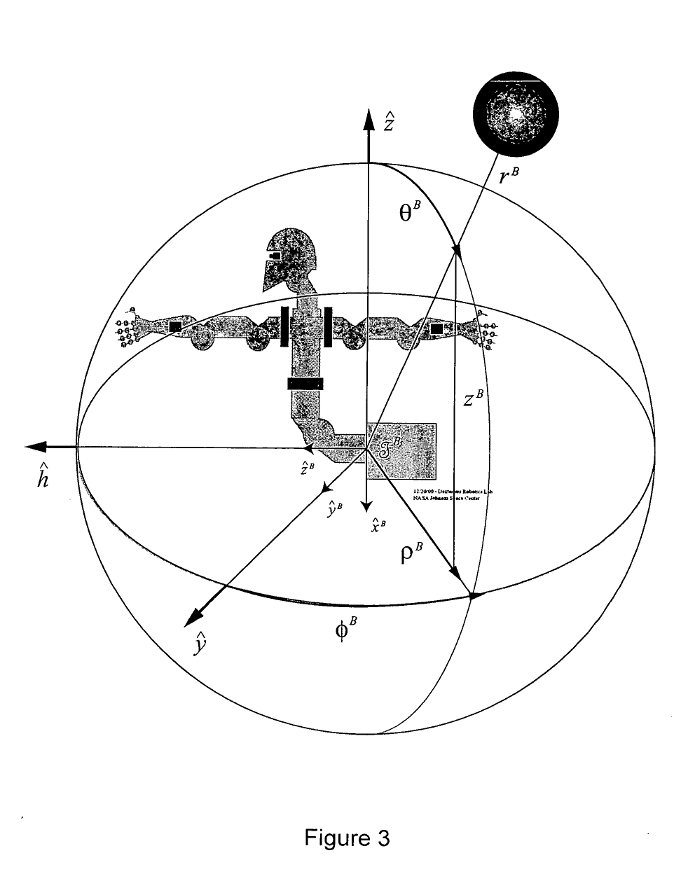

If a robot and its environment are stationary, then the locations of data will not move on the SES. If the base frame of the robot remains fixed in space over time, any articulated motion of the robot can be counteracted via its known kinematics (see FIG. 3). To correctly register moving objects on a stationary SES requires object tracking, and thus prediction and searching. Moreover if the base frame of the robot moves, the locations of data on the SES will also move both as functions of the heading and velocity of the robot and of the distances of the sensed objects from the robot. Thus, as the robot moves, the node locations of data on the SES must be shifted.

Purely rotational motion of the base frame is easily compensated for by oppositely rotating the SES. That aligns the SES with the environment while the robot moves within the SES. Translational motion of the base frame requires that object locations on the SES be shifted as a function of their distance from the base frame. Such shifting of the information is prone to error. This error is not critical since the estimated SES location of an object serves as the starting point for a sensory search of the environment to locate the object more exactly. In this capacity, the SES provides reasonable starting locations for searches, reducing the time necessary to track multiple objects.

As a robot moves, objects in its environment shift relatively. Thus, projections of objects move on the SES. If the robot's motion is known, the change in SES projection can be estimated for any object a known distance away. If the distance to an object is unknown, motion on the SES permits the distance to be estimated. Reciprocally, the concerted motions of a set of objects on the SES enable the robot to compute its motion relative to the objects. These estimation procedures also can alert the robot to independent motion by an object.

There are three types of motion transformation typically employed in the SES: pure translation, as when a mobile robot is traveling along a straight path; translation coupled with rotation, the most general case of ego-sphere motion; and articulated motion, as when a humanoid robot exercises it end-effectors with respect to its base frame. For implementation purposes, the details and description of these motions are contained in the Appendix.

Examples

Quantitative and qualitative results when the SES is used as a short-term memory, for spatial localization and navigation, for coincidence detection, and as an attentional mechanism are now described. These results were obtained from implementations of the SES on Vanderbilt's humanoid robot, ISAC, on NASA's humanoid robot, Robonaut, and on a mobile robot at Vanderbilt. See, for example, K. Kawamura, R. A. Peters II, D. M. Wilkes, W. A. Alford, and T. E. Rogers, “Isac: foundations of human-humanoid interaction,” IEEE Intelligent Systems, vol. 15, no. 4, pp. 38-45, July 2000, and R. O. Ambrose, H. Aldridge, R. S. Askew, R. R. Burridge, W. Bluethmann, M. Diftler, C. Lovchik, D. Magruder, and F. Rehnmark, “Robonaut: Nasa's space humanoid,” IEEE Intelligent Systems, vol. 15, no. 4, pp. 57-63, July 2000. These robots have sensory processing and motor control modules that operate in parallel continuously, independently, and asynchronously; additionally they communicate through message passing. See, for example, R. A. Peters II, D. M. Wilkes, D. M. Gaines, and K. Kawamura, “A software agent-based control system for human-robot interaction,” in Proceedings of 2nd International Symposium on Humanoid Robotics (HURO '99), Tokyo, October 1999. The SES is most effective when implemented on robotic architectures possessing these capabilities.

Short-Term Memory

As a short-term memory, the SES is useful for maintaining an inventory of objects in the robot's locale for subsequent manipulation or other action. The SES is currently being used in that way by ISAC at Vanderbilt, Robonaut at NASA-JSC, and Cog3 at MIT. See, for example, P. Fitzpatrick, “From first contact to close encounters: A developmentally deep perceptual system for a humanoid robot,” Ph.D. Dissertation, Massachusetts Institute of Technology, May 2003. The data structure of the SES used by Cog was developed independently and differs from that described here. When the robot recognizes an object, the location of a point of reference on the object (part of the object definition) and the object's pose are stored along with an identifier and time stamp at the closest SES node. The identifier is used as a tag by the SES for its search and recall routines. The time stamp can be used along with an activation decay constant to compute a probability that the object is at the recorded location after time has elapsed.

As the robot, its environment, or the object moves, its location is updated by the SES so that the robot always stores the object's position relative to the base frame. This position is likely to accrue errors if the robot is not actively tracking the object with its sensors. The SES, however, provides the starting location for a sensory search if the object is not found by the sensors at the recorded location upon later recall. The SES also maintains locations of objects if motion results in the occlusion of one object by another. The spatial layout of the SES keeps track of the spatial relationships between objects so that the robot can know “what is where.”

Because the SES manager rotates the nodes and shifts the data to compensate for motion of the robot's base frame, data from specific locations in the environment accumulate over time. Object recognition agents designed to monitor the SES can periodically analyze the data accumulating at a location. If the data is consistent with a known object the agent can tag the location with an object label and a confidence level.

Sensory-Motor Data Association

If parallel SPMs output to the SES, it can (3) associate sensory and motor data through spatio-temporal coincidence detection. When the SES receives data from direction (θₒ, φₒ) it adds activation, Aⱼ, to the node closest to (θₒ, φₒ). Represent that node by Nⱼ. Each node on the SES has either five or six neighbors connected by edges. FIG. 2 shows an example of a node and its immediate neighbor nodes. When activation is assigned to node Nⱼ, that activation is spread to all nodes that are within a given number of edges away. If node Nₖ is within range, it is assigned an activation value, Aⱼₖ, that is an exponential function of its angular distance Dⱼₖ from Nⱼ.
Dᵢₖ=\sqrt{(θₖ−θⱼ)²+(φₖ−φⱼ)²}, (2)
where (θⱼ, φⱼ) and (θₖ, φₖ) are the angular positions of the nodes Nⱼ and Nₖ with respect to the robot's base frame. Let Eⱼₖ be the number of edges in a shortest path between the nodes. Then the activation at node Nₖ due to Nⱼ is

$${A}_{jk} = \frac{1}{{E}_{jk}} {A}_{j} {ⅇ}^{- {α}_{s} {D}_{jk}} . \qquad ( 3 )$$

The amplitude, A, of the activation at Nⱼ can be supplied by the SPM that reported the event or it can be set by an attentional operator. The scale factor αₛ depends on the resolution of the sensor and is discussed below. The maximum number of edges to which activation is spread is determined empirically. Visual routines and motor controllers generally have the highest resolution whereas sonic localization and IR motion detection the lowest. Consequently, as is relatively small for the former and large for the later. The activation at node k is then given by

$${A}_{k} = {\sum }_{j} {A}_{jk} . \qquad ( 4 )$$

The activation values of the nodes indicate their relative importance at the current time. Each node contains a radial basis function (RBF) that spreads activation to its neighbors according to equations (2)-(3) above. If multiple data are registered in the same area at about the same time, activation will increase around a central node. For 1-D sensors, registration occurs only at the equatorial axis of the SES. Therefore, activation must be spread longitudinally so that events co-occurring away from the equatorial axis may overlap with the 1-D sensor events. Upon registration of data from a 1-D sensor, nodes along the longitude closest to the registration angle each receive activation as if they were the original node.

To perform coincidence detection, the node with the highest activation is selected. All data that contributed to the activation of that node is retrieved from the SES. Temporal coincidence can be detected using processing latencies of the SPMs, which can be measured experimentally. The latencies define a time interval during which all sensory events are considered to be simultaneous.

Tests of coincidence detection for sensory data association involved recognition of objects that were uniform in color, that were movable, and that could make sounds (i.e., an orange rattle, and a purple toy that talks). Objects were individually presented to the Vanderbilt humanoid, ISAC, producing 32 separate sets of multi-modal events. ISAC's stereo vision head can detect the angular position of an object to within an accuracy of 3°. Sonic localization and IR motion detection are far less accurate with average errors of 21° and 19°, respectively. Thus, the angular position of an event that produces sound, motion, and imagery may be grossly mismeasured by those two sensors. In 12 of the 32 trials, the error in measurement of both sound and IR exceeded 30° and was not detectable as a coincidence. When, however, the accuracy of all sensors was within 15° (seven of the 32 trials), the SES correctly detected the events as co-occurrent. For sound and IR measurement errors in the range of 15° to 30°, some coincidences were detected.

Within a neighborhood of two edges for IR and sound events and three for visual events, coincidence detection selected all co-occurring events in all the trials. Two of three events (visual, IR, sound) co-occurred within 15° while the third event co-occurred within 30° of the originating source in the remaining 25 trials. Within neighborhoods of two edges for IR and sound and within three, four, or five for vision, all co-occurring events were selected 24%, 28%, and 32% of trials, respectively. Note that these results are considerably higher than the baseline detection rate of approximately 10% if the sensors report independently.

An experiment comprising 21 trials was performed with two sources presented to the robot in succession at multiple locations. Each source generated three separate events (visual, IR, sound). In all of the trials, all co-occurring events from one source were selected. In 38.1% of trials, at least one event from each source was within 15° of another. In 9.5% of trials, all events from both sources were within 15° of each other. The cumulative time latency for visual, IR and sound events averaged three seconds while the time range used in coincidence detection was four seconds.

Eleven objects were individually presented to the Vanderbilt humanoid, ISAC. Each object produced visual data from color segmentation, motion data from IR motion sensors, and sound data from sound localization. The resolution of sensors were vision, 1°-3°, IR motion, 7°-17°, and sound, 15°. Sound localization correctly reported direction within 15° or less of the originating source during 54.5% of the trials while the IR sensors reported correctly within 15° during 81.8% of the trials. The vision system always reported correctly to within 3°. The cumulative time latency in each trial was eight seconds. Within a neighborhood of three edges, the events that output correct values (within 15° of the originating source) were selected in all the trials. The neighborhood can be increased or decreased depending on the resolution of the SPMs that send data to the SES.

An experiment comprising 40 trials was performed with multiple sources presented to the robot. The source that produced the most data (visual, sound, motion) was always selected. When all SPMs reported correctly, all co-occurring data were always selected. As the object separation approached the resolution of the sensors, incorrect results were reported. The current limit for these sensors appears to require a 20° separation between sources. This number is also a function of the latency.

Attention

The nodal activation vectors of the SES can be used to direct the attention of the modules that read data from the SES and, thereby, the attention of the robot. The SES can be biased toward the selection of specific data by modulating the strength of activations assigned to SES nodes. This bias is useful for directing the robot's attention during tasks such as picking up tools, or during contextual circumstances such as working with people. The attention network balances the trade-off between contextually important data and unexpected yet salient data.

The attention network combines the activation from the nodal RBFs to represent salience data in the environment with priority values that represent desired data. The focus of attention (FOA) is selected as the node that receives the highest combination of activation from both the RBFs and the priority values. This node is then sent through coincidence detection to determine which data originated from the same source.

Initial experiments have been performed on ISAC to determine at what level priority values shift the focus of attention from desired data to salient data. In these trials, the desired task for the robot was to grasp a turquoise beanbag. At 15-20 seconds after visual detection of the beanbag, a person moved back and forth in another area of the environment while clapping her hands, producing both sound and motion data. The event sources were approximately 90° apart so that neither contributed to the activation of overlapping nodes. Priority values were decreased from 5.0 to 0.1. During all trials, the beanbag was selected as the focus of attention. Since the vision sensors have a small resolution and high reliability, one visual event creates the same amount of activation from the RBF as a sound event and a motion event combined. Therefore, trials were repeated to include visual data from the person. Priority values were again decreased from 5.0 to 0.1. The beanbag was selected as the FOA until the priority value reached 1.0. At this point, the motion, sound, and person were selected as the FOA.

Spatial Localization and Navigation

Although the ego-centric representation within the SES has some known disadvantages for navigation, as described in S. Thrun, “Robotic mapping: a survey,” in Exploring Artificial Intelligence in the New Millenium, G. Lakemeyer and B. Nebel, Eds. Morgan Kaufmann, 2002, it does provide affordances that robotic mapping techniques may exploit to make their jobs easier. The results of one such use of the SES—for topological navigation—are briefly described here.

Assume that a robot has been provided with a sparse allocentric map (AMAP) of its global environment that includes the relative locations of various landmarks that it can sense (visually or otherwise). The AMAP can be projected onto the SES to form an ego-centric map (EMAP) of the robot's locale. Given a destination, the robot can use the AMAP to derive a sequence of via-locations in the form of EMAPs that it can use for navigation. When implemented on a mobile robot at Vanderbilt, the robot was able to visually navigate through an obstacle course to goals in both indoor and outdoor environments. See, for example, K. Kawamura, A. B. Koku, D. M. Wilkes, R. A. Peters II, and A. Sekmen, “Toward egocentric navigation,” International Journal of Robotics and Automation, vol. 17, no. 4, pp. 135-145, October 2002. Given the angles from its base frame to three or more expected landmarks the robot can determine its desired position within the locale. Any two landmarks on the EMAP together with the ego-center define a plane that cuts a great circle on the SES. The nodes on the SES near great circles through pairs of landmarks on the EMAP can be searched for data that corresponds to expected landmarks. If three or more landmarks are found, the robot can triangulate to determine its actual position within the locale. To center itself, the robot moves in the direction of the EMAP center until the objects on the great circle on the SES match positions with those on the EMAP. The approach is robust to perturbations in the locations of landmarks on the AMAP providing that most of their projections onto the SES are ordered as sensed in the environment. That is the algorithm was developed with the assumption that AMAP locations could have errors about the relative positions of landmarks. The algorithm proved robust under those conditions.

The Sensory Ego-Sphere has been described and presented as an interface between a robot's sensors and cognitive mechanism. Several of the affordances of the interface were described, in particular its function as a short-term memory, its ability to aid in spatial localization and navigation, its ability to associate sensory-motor data, and its ability to serve as an attentional mechanism. The SES has been implemented on a variety of robots, including mobile robots at Vanderbilt and humanoid robots at Vanderbilt (ISAC) and NASA (Robonaut).

The utility of the SES as an interface lies in its two representations: externally it can be visualized as an ego-centric sphere around the robot, and internally as a spatially structured graph. Thus, if parallel, independent sensory processing modules write to the SES, it implicitly associates multi-modal sensory-motor data. The spherical ego-centric structure is a representation of the local environment that is less computationally complex than a full 3-D representation. The spatio-temporal indexing of the SES organizes data naturally into a topology-preserving short-term memory. This organization aids object recognition by the accumulation of sensory cues over time. It facilitates the direction of attention to events that stimulate multiple sensors. Also, it enables localization of the robot and its navigation through the world by providing an ego-centric landmark map that can be quickly matched to data gleaned from allocentric representations.

Another use of the SES that we are exploring is as an interface facilitating the sharing of data by multiple robots and as a display of robotic data in a remote control center. Information about the current ego-centric locations of known objects or landmarks within an environment can be coded compactly in an SES. All that is needed is a label and a space-time location. By transmitting that information to a remote supervisor or to another robot, either can set up its own copy of the robot's current SES. Depending on the data that is transmitted, the picture painted by the sensors on the dome can be displayed to give a supervisor a cockpit view of the robot in operation. Over a low bandwidth communications channel, the space-time position and label data can be used by a command center to construct an iconic representation of a robot's environment. Broadband communications could enable a full immersion telepresence at the supervisor console. If two distinct robots in the same locale share SES information they augment their individual capacity for sensing. Robot A can send the contents of its SES to robot B to enable B to navigate to A's precise location. By merging their SES's a team of robots can create a virtual SES that encompasses all of them.

The problem of enabling a robot to learn from experience by building models of the dynamics of its own sensory and motor interactions with objects and tasks is now described. (see, for example, Peters, R. A., II, K. Kawamura, D. M. Wilkes, D. M. Gaines, R. O. Ambrose, “Robot learning and problem solving through teleoperation with application to human-robot teaming: a white paper”, Center for Intelligent Systems, Vanderbilt University. Unpublished manuscript available for download from, http://www.vuse.vanderbilt.edu/rap2/papers/Robot Learning White Paper 2020001129.pdf, November 2000). This interaction is initially provided by fine-grained teleoperator inputs. Over time, information gleaned from teleoperator guidance is compiled into autonomous behaviors so that the robot can perform tasks on its own and so that the level of discourse between operator and robot can become more abstract.

The approach described here builds on the self-organization of sensory-motor information in response to a robot's actions within a loosely structured environment. In Pfeifer, R. and C. Scheier, “Sensory-motor coordination: the metaphor and beyond,” Robotics and Autonomous Systems, Special Issue on “Practice and Future of Autonomous Agents,” vol. 20, No. 2-4, pp. 157-178, (1997), Pfeifer reported that sensory data and concurrent motor control information recorded as a vector time-series formed clusters in a sensory-motor state-space. He noted that the state-space locus of a cluster corresponded to a class of motor action taken under specific sensory conditions. In effect, the clusters described a categorization of the environment with respect to sensory-motor coordination (SMC).

An exemplar of an SMC cluster corresponds at once to a basic-behavior as defined by Brooks (see, for example, R. A. Brooks, “A Robust Layered Control System for a Mobile Robot,” IEEE Journal of Robotics and Automation, Vol. RA-2, pp. 14-23, April 1986) and to a competency module in a spreading activation network (see, for example, P. Maes and R. A. Brooks, “Learning to Coordinate Behaviors,” Proc. Eighth National Conf. on Artificial Intelligence, Vol. AAAI-90, pp. 796-802, 1990). The latter is a specific example of a more general class of topological, action-map representations of an environment (see, for example, M. J. Matarić, “Integration of Representation Into Goal-Driven Behavior-Based Robots”, IEEE Transactions on Robotics and Automation, Vol. 8, No. 3, pp. 304-312, June 1992), which can controlled by discrete-event dynamical systems (DEDS) with transition probabilities given by Markov decision processes. A description of DEDS is presented in Huber, M., R. A. Grupen, “A Hybrid Discrete Event Dynamic Systems Approach to Robot Control”, UMass Computer Science technical re-port, No. 96-43, University of Massachusetts, Department of Computer Science, October 1996 and in Huber, M., A Hybrid Architecture for Adaptive Robot Control, Ph.D. Dissertation, University of Massachusetts, September 2000. If the state-space is parameterized by time, the clusters are collections of trajectories and an exemplar is a single representative trajectory through the space.

Thus, if a robot is controlled through an environment to complete a task while recording its SMC vector time-series, the result is a state-space trajectory that is smooth during the execution of a behavior but that exhibits a corner or a jump during a change in behavior (an SMC event). From this, a DEDS description of the task can be formed as a sequence of basic behaviors and the transitions between them. The task is learned in terms of the robot's own sensors, actuators, and morphology.

The autonomous execution of fixed motor trajectories by a DEDS controller that changes state in response to SMC events will fail if the operating environment differs significantly from the learning environment. On the other hand, if a set of trajectories is learned that bounds or covers the variations of the task, the task might be performed successfully under more conditions. In particular, a new situation might be successfully negotiated through a superpositioning of the bounding trajectories.

The results of learning to reach toward and grasp a vertically oriented object at an arbitrary location within the robot's workspace by superpositioning a set of SMC state space trajectories that were learned through teleoperation are now described. The ideas behind the procedure are based on a number of assumptions: (1) When a teleoperator performs a task it is her/his SMC that is controlling the robot. So controlled, the robot's sensors detect its own internal states and that of the environment as it moves within it. Thus the robot can make its own associations between coincident motor actions and sensory features as it is teleoperated. (2) In repeating a task several times, a teleoperator will perform similar sequences of motor actions whose dynamics will depend on his/her perception of similar sensory events that occur in similar sequence. As a result, the robot will detect a similar set of SMC events during each trial. Therefore each trial can be partitioned into SMC episodes, demarcated by the common SMC events. (3) Sensory events that are salient to the task will occur in every trial; sensory signals that differ across trials are not significant for the task and can be ignored. By averaging the time-series for each episode point-wise over the trials, a canonical representation of the motor control sequence can be constructed. As a result of the averaging, true events in the sensory signals will be enhanced and those that are random will be suppressed.

Related Work

This work extends that reported by Peters, R. A., II, C. L Campbell, W. J. Bluethmann, and E. Huber, “Robonaut Task Learning through Teleoperation”, Proc. 2003 IEEE Int'l. Conf. on Robots and Automation, Taipei, Taiwan, 12-17 May 2003 where a single trajectory was learned over 6 trials that could later be performed autonomously with success in the face of small variations in the environment or perturbations of the goal. In addition to Pfeifer, R. and C. Scheier, “Sensory-motor coordination: the metaphor and beyond,” Robotics and Autonomous Systems, Special Issue on “Practice and Future of Autonomous Agents,” vol. 20, No. 2-4, pp. 157-178, 1997, many others have studied the extraction of SMC parameters, including Cohen in Cohen, P. R., “Learning Concepts by Interaction”, University of Massachusetts Computer Science Department Technical Report 00-52, 2000, and Cohen, P. R. and N. Adams, “An Algorithm for Segmenting Categorical Time Series into Meaningful Episodes”, Proc. Fourth Symposium on Intelligent Data Analysis, vol. 2189, pp. 198-207, 2001, Grupen in Coelho, J., J. Piater, and R. Grupen, “Developing haptic and visual perceptual categories for reaching and grasping with a humanoid robot”, Proc., Humanoids 2000, The 1st IEEE-RAS Int'l Conf on Humanoid Robots, Massachusetts Institute of Technology, Sep. 7-8, 2000, and Peters in Cambron, M. E., and Peters II, R. A., “Determination of sensory motor coordination parameters for a robot via teleoperation”, Proc. 2001 IEEE Int'l Conf. on Systems, Man and Cybernetics, Tucson, Ariz., October 2001. Like Pfeifer, Cohen concentrates on learning categories from random behaviors. However, he manually designates the episode boundaries and uses categorization techniques to find similarities between the episodes. While such clustering may become important as more tasks are incorporated, the behaviors in this work can be automatically clustered by their locations in the task sequence. Grupen experimented with DEDS of parallel controllers that are quite similar in theory to the autonomous parts of the work described here. His systems use but do not learn low-level SMC trajectories for motion control, and have mainly focused on grasping and dexterous manipulation. Grupen's work appears be compatible with that described here, as discussed below. The use of motion data to plan robotic motion is a problem that has been studied by, and reported in M. J. Mataric, “Getting Humanoids to Move and Imitate”, IEEE Intelligent Systems, July 2000, 18-24. vol. 15, no. 4, pp. 18-24, July-August, 2000, O. C. Jenkins and Matarić, M. J., “Deriving Action and Behavior Primitives from Human Motion Data”, IEEE/RSJ Int'l. Conf. on Intelligent Robots and Systems (IROS 2002), Lausanne, Switzerland, pp. 2551-2556, 2002, Ude, A., C. G. Atkeson, and M. Riley, “Planning of Joint Trajectories for Humanoid Robots Using B-Spline Wavelets”, Proc. of the IEEE Int'l. Conf. on Robotics and Automation, San Francisco, Calif., pp. 2223-2228, April 2000, and Pollard, N. S., J. K. Hodgins, M. J. Riley, and C. G. Atkeson”, “Adapting Human Motion for the Control of a Humanoid Robot”, Proc. of the IEEE Int'l. Conf. on Robotics and Automation, Washington, D.C.”, May 2002. Matarić and Jenkins have enabled a simulated humanoid to learn unconstrained motion patterns from human motion-capture data. Our work modifies one of their segmentation and data normalization procedures. Moreover, Jenkins has studied the creation of new motions through the interpolation of learned trajectories using Isomap as described in Tenebaum, J. B., V. de Silva, and J. C. Langford, “A Global Geometric Framework for Nonlinear Dimensionality Reduction,” Science, v. 290, 22 December 2000, pp. 2319-2323. Another difference is that they create new unconstrained motions (waving, dancing, semaphore, etc.) from the learned ones without consideration of sensory data. The work of Ude et al. and Pollard et al. also create free-space motions but their methods do not require accurate end-effector placement for grasping. Similar to the work reported here, they taught a robot motions through the imitation of a person. However, the complexity of data analysis in their procedures was reduced in this one by the use of teleoperation. The data that they received from motion capture had to be mapped onto their robot's joints.

The experiments for this paper were performed on Robonaut, NASA's space-capable, dexterous humanoid robot. Robonaut was developed by the Dexterous Robotics Laboratory (DRL) of the Automation, Robotics, and Simulation Division of the NASA Engineering Directorate at Lyndon B. Johnson Space Center in Houston, Tex. as described in Ambrose, R. O., H. Aldridge, R. S. Askew, R. R. Burridge, W. Bluethmann, M. Diftler, C. Lovchik, D. Magruder, F. Rehnmark, “Robonaut: NASA's space humanoid”, IEEE Intelligent Systems, IEEE Intelligent Systems, vol. 15, no. 4, pp. 57-63, July-August, 2000. In size, the robot is comparable to an astronaut in an EVA (Extra-Vehicular Activity) suit. The 7-DOF robonaut arm is approximately the size of a human arm, with similar strength and reach but with a greater range of motion. It mates with a 12-DOF hand to produce a 19-DOF upper extremity. The robot has manual dexterity sufficient to perform a wide variety tasks requiring the intricate manipulation of tools and other objects.

Although physically capable of autonomous operation, Robonaut's primary mode of control is through full-immersion teleoperation by a person. In this mode, every motion that the robot makes is a reflection of a similar motion made by the human teleoperator. The teleoperator wears a helmet that enables her/him to see through the robot's stereo camera head and to hear what the robot hears. The robot has stereo microphones for terrestrial use; radio would be used in space. Sensors in gloves worn by the teleoperator determine finger positions. Six-axis Polhemus sensors on the helmet and gloves determine the arm and head positions. A description of the sensors is provided in Krieg, J. C., “Motion Tracking: Polhemus Technology”, Virtual Reality Systems, vol. 1, No. 1, pp. 32-36, March, 1993.

Robonaut's arm-hand systems have a high band-width dynamic response that enable it to move quickly, if necessary, under autonomous operation. During teleoperation, however, the response of the robot is slowed to make it less susceptible to jitter in the arms of the teleoperator and to make it safe for operation around people, either unprotected on the ground or in pressurized EVA suits in space. The purposeful limitation of maximum joint velocity affects not only the motion analysis described below but also the superposition of learned behaviors, especially with respect to the time-warping of component behaviors.

Behavior Superposition

There were four phases in the data gathering and analysis for this learning task:

A teleoperator controlled the robot through the tasks that would serve as examples. Five trials at each of nine locations were performed of a reach and grasp of a vertically oriented object (a wrench). As the teleoperator performed these example motions, Robonaut's sensory data and motor command streams were sampled and recorded as a vector time-series or signal.

The SMC events common to all trials were found and used to partition the signal into episodes. The episodes were time-warped so that the jth episode in the kth trial had the same duration (and number of samples) as the jth episode in every other trial.

The signals were averaged over all five trials at each location to produce a canonical, sensory-motor data, vector time-series for each location. This approach is similar both to that of O. C. Jenkins and Matarić, M. J., “Deriving Action and Behavior Primitives from Human Motion Data”, IEEE/RSJ Int'l. Conf. on Intelligent Robots and Systems (IROS 2002), Lausanne, Switzerland, pp. 2551-2556, 2002 and to those analyzed by in Cohen, P. R. and N. Adams, “An Algorithm for Segmenting Categorical Time Series into Meaningful Episodes”, Proc. Fourth Symposium on Intelligent Data Analysis, vol. 2189, pp. 198-207, 2001.

These generalized motions were combined using the process described by Rose, C., M. Cohen, and B. Bodenheimer, “Verbs and Adverbs: Multidimensional Motion Interpolation”, IEEE Computer Graphics and Applications, Vol. 18, No. 5, pp. 32-40, September 1998 called Verbs and Adverbs.

When the process completed, the resulting set of parameters could be saved to file and then used to create a general representation of the task that was adaptable under real-time conditions.

Teleoperation

The task performed by the teleoperator was to reach forward to a wrench affixed to a frame, grasp the wrench, hold it briefly, release it, and withdraw the arm. The frame made it possible to re-position the wrench as needed while keeping it steady during task performance. For the purposes of these experiments, the wrench was positioned in a reachable, nearly vertical position. Nine example locations were chosen. Eight of these were positioned approximately at the corners of a box that defined the limits of the reachable workspace. The ninth was a point near the middle of the box. Five trials were repeated at each of the nine locations.

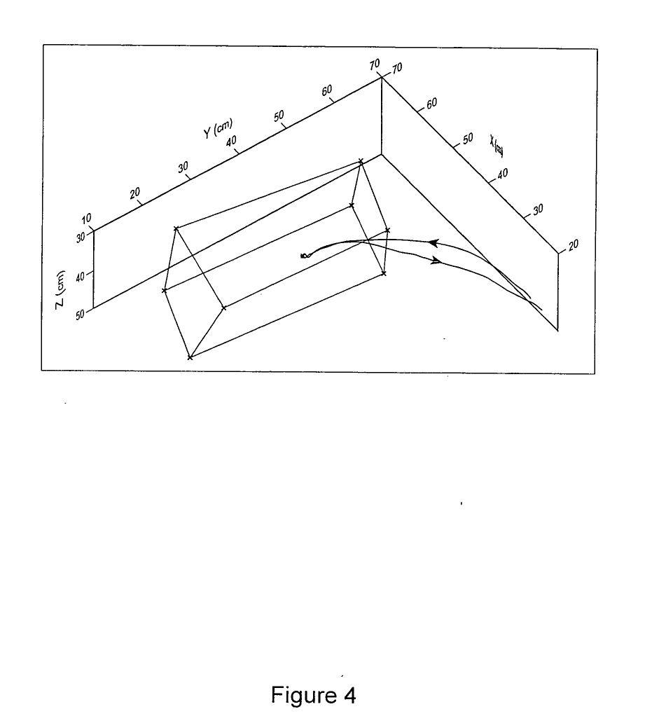

FIG. 4 shows a 3D plot of the locations, with lines drawn to indicate the box which is a warped parallelopiped. The curve in the middle is a plot of the end effector's point of reference throughout one of the five trials where the object was at the central position. The box is depicted from the viewpoint of one of Robonaut's cameras. The coordinate frame used for all Cartesian locations in this paper is centered on Robonaut's chest. The x-axis points out, the y-axis points right, and the z-axis points down. Note in the figure that the y-dimension of the box is much longer than the x- and z-directions.

Segmentation

The time-series data from the experiment was manually segmented into 45 trials according to markers embedded in the voice channel of the robot's data stream. Then each trial was partitioned into five SMC episodes (reach, grasp, hold, release, withdraw) demarcated by SMC events that were found through an analysis of the mean-squared velocity (MSV) of the joint angles, φᵢ,

$$z = {\sum }_{i} {\dot{ϕ}}_{i}^{2} . \qquad ( 5 )$$

the sums of the squares of all the joint velocities in the arm-hand system. See for example, Fod, A., M. J. Matarić, and O. C. Jenkins, “Automated Derivation of Primitives for Movement Classification”, Autonomous Robots, vol. 12 no. 1, pp. 39-54, January 2002. In this work, the trials were demarcated manually and each trial was segmented automatically into episodes. The trials could have been likewise extracted automatically, but were not since episode extraction was the focus the work.

An SMC event was defined as the beginning or end of a sufficiently large peak in the MSV, since that corresponded to a significant acceleration or deceleration in the arm-hand system. A peak was detected at time t₀ if (1) z(t₀) exceeded a threshold, c, and (2) z(t) exceeded 15c at some time t₁>t₀ before falling below the lower threshold at a time t₂>t₁. That is an SMC event was marked at time, t₀, if
z(t₀−1)<c AND z(t₀)≧c AND z(t₁)>15c (6)
for some t₁>t₀ providing that z(t)>c for all tε(t₀, t₁). The end of the peak was detected at time t₂ if,
z(t₂−1)>c AND z(t₂)≦c AND z(t₁)>15c (7)
for some t₁<t₂ providing that z(t)>c for all tε(t₁, t₂).

A threshold of c=0.02 was derived empirically as the fifth percentile of the distribution of measured accelerations. That is, let z* be the largest value of z measured throughout the trials. The value of c was increased from 0.001z* to 0.1z* in increments of 0.001z*. For each c, the mean and standard deviation of z(t)>c was computed. The standard deviation increased (roughly) logarithmically but leveled off at an asymptote of approximately 0.6z*. The 95th percentile (0.57z*) was reached at c≈0.02. The factor of 15 was used for the upper threshold because it yielded the number of episodes that were expected.

The MSV was found to be an excellent indicator of the grasp, hold, and release events if the hand joint velocities were included in it. It was not reliable in detecting those events if only the arm joint velocities were included. The vector time-series between two SMC events were taken as SMC episodes that corresponded to distinct behaviors.

Time Warping: Normalization and Averaging

Once the segmentation of the data was complete, the SMC episodes that comprise the task were time-warped through resampling to have a duration equal to the average duration of the 45 trial episodes. Then for each of the 9 locations the average vector time-series was computed from the five corresponding trials. For example, the reach behavior averaged 150 time steps across the 45 trials. Each of the time-series that comprised the reach episodes was time-warped and resampled to have length 150. The five reach episodes from the five trials at each location were averaged to create nine exemplar reach episodes each with 150 samples in duration.

The effect of averaging the time-normalized episodes across the five trials at each location was to enhance those characteristics of the sensory and motor signals that were similar in the five and to diminish those that were not. Averaging would produce a skewed result if one of the five episodes were significantly different from the others. That could be overcome by selecting the median episode. However, it was a premise of this work that episodes would not differ significantly from each other in their salient features. If that premise were incorrect, it would not be possible to characterize a repeated motion through the type of analysis described here. But, the premise was found to hold in these particular experiments.

Through the four-step procedure nine sensory-motor state-space trajectories were created. These were taken to be the exemplars of the clusters formed by the five trials of the reach-and-grasp task at each of the nine locations. A more detailed description of the procedure follows.

Assume there were M trials T₁, . . . , T_{M} of the task performed. For each trial, Tᵢ, assume N separate signals (data channels) s_{i,j}(t), were recorded. Then
vᵢ(t)=[s_{i,1} . . . s_{i,N}]^{T}(t) (8)
is the vector time-series recorded during trial Tᵢ. In general, s_{i,j}(t) is itself a vector time-series, such as 3-axis force. But s_{i,j}(t) could also be a scalar signal such as a joint angle. Assume that t is discrete, defined only at integer multiples of the sampling interval, τ, (for these experiments τ=0.1 s) so that
tε{ητ}ₙ₌₁^{∞}. (9)
Hence, without loss of generality one can define tεZ⁺, the positive integers.

By assumption, each trial (i) contains the same number, P, of SMC episodes, denoted by E_{i,k}, which follow the same sequence, E_{i,1}, . . . , E_{i,p}, within each trial. Moreover,
E_{i,k}={vᵢ(t)}ₜ₌₍ₜ_{_{i,k−1)+1}}^{t}^{_{i,k}}, (10)
for k={1, . . . , P}, where t_{i,k} is the time at which the kth episode, E_{i,k}, ends in trial Tᵢ. We define 1+t_{i,0} as the starting time of trial Tᵢ. Note that in general
t_{η,k}−t_{η,k-1}≠t_{v,k}−t_{v,k-1}. (11)
That is, the kth episode from trial _{q} will not have the same duration as the kth episode from trial v. If all were recorded with the same sampling interval, T, then the number of samples in corresponding episodes will differ. Let # {•} represent the cardinality operator so that # (E_{z,k} l is the number of samples in episode k of trial i. Then usually
#{E_{η,k}}≠#{E_{v,k}}, for η≠ν (12)
To compute a characteristic representation of the task, the corresponding episodes in each task must have the same duration—the same number of samples. Therefore each episode, E_{η,k}, was resampled to form a new one, E′_{η,k} such that

$$\# \{ {E}_{1 , k}^{′} \} = … = \# \{ {E}_{M , k}^{′} \} = \frac{1}{M} {\sum }_{i = 1}^{M} \# \{ {E}_{1 , k}^{′} \} \qquad ( 13 )$$

That is, the length of episode E′_{i,k} is the average over all trials of the number of samples in kth episode. Thus,
E′_{i,k}={v′ᵢ(t)}ₜ₌ₜ_{_{i,k−1}}^{t}^{_{i,k}}, (14)
where v′ᵢ(t) is the resampled vector time-series,
v′ᵢ(t)=[s′_{i,1} . . . s′_{i,N}]^{T}(t) (15)
and indices {t_{i,k}}ₖ₌₁^{P} have been reassigned to the new time-series.

Given the dynamics of Robonaut under teleoperation—its maximum velocity is limited—the durations of the episodes are relatively long and the sampling rate well exceeds the Nyquist limit. Thus the salient sensory-motor characteristics are well represented in all the trials at each of the locations and time warping for episode normalization preserves those characteristics. This would not necessarily be the case if the sampling rate were near the Nyquist limit and some of the episodes were of short duration.

Superposition using Verbs and Adverbs

The motion data was then ready for the processing that allowed the separate examples to be combined into a motion that could reach and grasp a vertically oriented wrench anywhere within the workspace. This was done with an interpolation method called Verbs and Adverbs, developed in the computer graphics community by Rose et al. See, for example, Rose, C., M. Cohen, and B. Bodenheimer, “Verbs and Adverbs: Multidimensional Motion Interpolation”, IEEE Computer Graphics and Applications, Vol. 18, No. 5, pp. 32-40, September 1998. The following description is an adaptation of the algorithm from that paper. Table I lists symbols used in the description.

A verb in this implementation of the algorithm is the motion component of a task exemplar, its motion trajectory in the sensory-motor state-space. Let S represent the motion state-space; dim(S)=Nₛ. Define mᵢ(t): [symbol] →S to be the value at time t of the motion state trajectory of the ith exemplar. Let mᵢεS× [symbol] represent mᵢ(t) over all time, the trajectory in its entirety. Let m represent an arbitrary motion state trajectory.

TABLE I
Symbols for Verbs and Adverbs algorithm.

| Symbol | Dimension | Meaning |
|---|---|---|
| A | Nₐ | adv. space, Nₐ = no. of adv.s |
| E | Nₑ | exemplar state space |
| S | Nₛ | motion state space, Nₛ. = no. of states |
| Φ[•] | (Nₛ, + I) × N_{a,} | exact mapping from A to S × R |
| A(t) | Nₛ × (Nₐ + 1) | LMS approx. of Φ, rows: aⱼ^{T} (t) |
| M(t) | Nₛ × Nₛ | exemp. state mat. mᵢ(t) cols, nⱼ^{T} (t) rows |
| P(t) | (Nₐ + I) × Nₑ | hom. adv. exemplar matrix, cols: pᵢ^{h} |
| Q(t) | Nₑ × N, | interp. mat., col. j: RBF amps. for state j |
| R | Nₑ × Nₛ | matrix of RBF intensities at adv. locations |
| aⱼ(t) | Nₐ + 1 | affine coeff. vect. that maps pᵢ^{h} to mᵢⱼ(t) |
| m | Nₛ + 1 | motion state (vect.) traj. |
| m″ | Nₛ + 1 | LMS approx. of motion state traj. |
| mᵣₑₛ | Nₛ + 1 | motion state residual: m − m″ |
| m(t) | Nₛ | motion state vect. at time t |
| mᵢ | Nₛ + 1 | trajectory of motion state exemplar i |
| mᵢ (t) | Nₛ | state vect. of motion exemplar i at time t |
| m(p; t) | Nₛ | state vect. of motion with adv. p at time t |
| nⱼ(t) | Nₑ | vect. of state j from all exemplars at time t |
| p | Nₐ | adv. space vect., an adv. or adv. loc. |
| pᵢ | Nₐ | adv. corresponding to exemplar motion i |
| pᵢ^{h} | Nₐ + 1 | homogeneous pᵢ; is = [1 p^{T}]^{T} |
| q | Nₑ | vect. of RBF amplitudes |
| r(p) | Nₑ | vect. of exemplar RBF intensities, rᵢ(p) |
| u | Nₑ | RBF mags. at each adv. location due to q |
| cᵢ | 1 | decay constant for RBF at adv. pᵢ |
| mᵢⱼ(t) | 1 | jth component of (state in) mᵢ(t) |
| ρᵢ(p) | 1 | distance from exemplar adv. pᵢ to p E A |
| rᵢ(p) | 1 | mag. at p of RBF at adv. pᵢ |
| rᵢⱼ | 1 | rᵢ(pᵢ), intensity at jth adv. of ith RBF |

An adverb, p, is an Nₐ-dimensional vector in adverb space, A, that characterizes in some way a particular motion trajectory, m. The adverb is a specific parameterization of the motion trajectory. Thus by implication there exists a mapping
Φ:A→S×, (16)
such that
mᵢ=Φ[pᵢ] (17)
for each of the Nₑ motion trajectory—adverb pairs, (mᵢ, pᵢ). Generally, the mapping is unknown for trajectories other than the exemplars. The Verbs and Adverbs algorithm, in effect, computes Φ to find a trajectory, m, for a given parameterization, p.

In Rose, C., M. Cohen, and B. Bodenheimer, “Verbs and Adverbs: Multidimensional Motion Interpolation”, IEEE Computer Graphics and Applications, Vol. 18, No. 5, pp. 32-40, September 1998, several example motions were created for articulated characters. The mapping of these motions into a multidimensional adverb space defined extremal points along axes of the space. A particular adverb extremum characterized the appearance of the associated motion. To create motions that exhibited combinations of the characteristics, a location in the adverb space was selected and mapped back into the motion space. In this work, the adverbs are the 3D Cartesian world coordinates of the object to be grasped (the wrench). Exemplar reach-and-grasps were acquired near workspace extrema for the robot's right arm. To perform the operation at other locations in the workspace, the Verbs and Adverbs algorithm was used to interpolate the exemplar motions.

The algorithm projects the motion exemplars at each time t onto an Nₐ+1-dimensional subspace of the motion state space, S. That subspace is the range of a matrix, A(t) that is the least-mean-square (LMS) approximation of Φ[•](t). This is inaccurate so a radial basis function (RBF) interpolation operator is defined that restores the exemplar's components lost in the projection. Given a new adverb (in this case, a new grasp location), p, the corresponding motion, m(t), is found by computing m(t)=A(t)p then adding to that the corresponding RBF interpolation of the exemplars. This approach permits a limited extrapolation of the data since the subspace projection can construct new trajectories that extend parametrically beyond the exemplars.

Linear Approximation: The LMS subspace is found by deriving an approximation of Φ directly for each time step (sample) of the exemplars. Since the ith adverb, pᵢ, is functionally related to the ith motion exemplar, mᵢ (for i=1, . . . ,Nₑ), each state, mᵢⱼ(t) (for j=1, . . . ,Nₛ), at each instant, t, is likewise. Assume the relationship is first-order (affine). Then at time t state j of exemplar i is related to the ith adverb through a vector of coefficients, aⱼ(t)ε [symbol] ×A as follows:
mᵢⱼ(t)=[pᵢ^{h}]^{T}aⱼ(t) (18)
where pᵢ^{h}=[1 pᵢ^{T}]^{T} is a homogeneous representation of the adverb space pre-image of mᵢ. To compute all the states of all exemplars at time t use
M(t)=A(t)P. (19)
M(t) is the Nₛ×Nₑ matrix of exemplar states at time t. The ith column of M(t) is mᵢ(t), the vector of Nₛ state values of exemplar i at time t. The jth row of M(t) is nⱼ^{T}(t), the transpose of the vector that contains the jth state of all Nₑ exemplars at time t. P is the (N_{a,}+1)×Nₑ constant matrix whose ith column is pᵢ^{h}, the (homogeneous representation of the) ith adverb vector. A(t) is the Nₛ×(Nₐ+1) matrix whose jth row is aⱼ^{T}(t), the transpose of the vector of coefficients, which are unknown. There is one aⱼ(t) for each state variable at each time step in a motion trajectory.

If Φ[•](t) were linear then,
M(t)=Φ[P](t)=A(t)P. (20)
Probably Φ is not linear so equation (20) does not hold. Instead the A(t) is found that minimizes the mean-squared error,
∥M(t)−M″(t)∥², where M″(t)=A(t)P. (21)
The LMS solution is
A(t)=M(t)P^{T}[PP^{T}]⁻¹. (22)
Then
M″(t)=A(t)P=M(t)P^{T}[PP^{T}]⁻¹P. (23)
Matrix A(t) maps pᵢ^{h}, which contains the adverb associated with exemplar i, into m″ᵢ (t), which is the orthogonal projection of mᵢ (t) onto the range of the LMS approximation of Φ. For any adverb, pεA, the approximate motion state-vector at time t is, therefore,
m″(t)=A(t)p^{h}. (24)

Interpolation: Trajectory m″, as computed with equation (24) over all t, is a linear subspace approximation of the true trajectory, m. Usually Nₐ+2, the dimension of the subspace, is considerably smaller than Nₛ+1, which means that the approximation is, likely, not very accurate. In fact, it is usually the case that
M(t)≠M″(t)=A(t)P; (25)
the mapping is incorrect even at the known points. Let M_{Res}(t) represent the residual,
M_{Res}(t)=M(t)−M″(t). (26)
Radial basis functions can be used to define a function, f, that augments the LMS transform so that
M(t)=A(t)P+f(P), (27)
the resultant transform holds for all the exemplars. RBFs so defined act as interpolation functions so that an arbitrary adverb maps to a combination of the exemplar motions.

An RBF is defined at each adverb location, one for each exemplar. Rather than computing the states for each exemplar, the RBFs are used to compute the values of all exemplars at each state. That is a transform fⱼ is found such that
nⱼ(t)=fⱼ(P), (28)
the adverbs are mapped to the jth state of the residual in all Nₑ exemplars. Let rᵢ be an RBF defined at the ith adverb location, pᵢ. Its intensity at any point pεA is
rᵢ(p)=e^{-c}^{ᵢ}^{ρ}^{ᵢ}^{²}^{(p)} (29)
where
ρᵢ(p)=∥p−pᵢ∥, (30)
the distance from p to pᵢ. Parameter cᵢ determines the falloff in intensity of the ith RBF as the distance from it increases. For the reach-and-grasp experiments these were computed as

$${c}_{i} ( p ) = \frac{2 ln 10}{{min}_{j \neq i} \{ {‖ {p}_{j} - {p}_{i} ‖}^{2} \}} \qquad ( 31 )$$

so that at pⱼ, the exemplar adverb closest to pⱼ, the intensity was rᵢ(pⱼ)=0.01.

Define R as the Nₑ×Nₑ matrix of RBF intensities at the locations of the Nₑ adverb vectors.
R=[rᵢₖ] where rᵢₖ=rᵢ(pₖ), (32)
for i, kε{1,2, . . . ,Nₑ}. The ith row of R contains the values of the ith RBF measured at each adverb location. The kth column contains the values of all the RBFs measured at the location of adverb k. To find f in equation (27) a vector, qⱼ(t)=[qⱼ₁(t) . . . q_{jNe}(t)]^{T} is needed so that
nⱼ(t)=R^{T}qⱼ(t). (33)

Vector qⱼ(t) is a vector of amplitudes for the RBFs that causes their intensities to sum to the correct differences for state j at time t. For all Nₛ states, this becomes
M_{Res}^{T}(t)=R^{T}Q(t) (34)
where Q(t) is an Nₑ×Nₛ matrix. Since M_{Res}(t) and R are known, Q (t) can be found by inverting R,
Q^{T}(t)=M_{Res}(t)R⁻¹ (35)

If R is not invertible, an appropriate pseudo-inverse can be employed. With this, the exemplar adverbs will map to their corresponding trajectories through
M(t)=A(t)P+Q^{T}(t)R (36)
or for exemplar i,
mᵢ(t)=A(t)pᵢ^{h}+Q^{T}(t)r(pᵢ) (37)

This is an obvious result since Q^{T}(t)R=M_{Res}(t) if R is invertible. If an arbitrary adverb, p, is used in equation (37) however, Q^{T}(t)r(p) interpolates M_{Res}(t) to produce a “difference” estimate, mᵣₑₛ(t) for the associated motion state vector, m(t).

Given a grasp location p, a trajectory was computed by
m(t)=A(t)p^{h}+Q^{T}(t)r(p), (38)
for each time step t.

In addition to the method described above, two other methods were used to perform the reach-and-grasp autonomously. The first method, called AutoGrasp and described in Peters, R. A., II, C. L Campbell, W. J. Bluethmann, and E. Huber, “Robonaut Task Learning through Teleoperation”, Proc. 2003 IEEE Int'l. Conf. on Robots and Automation, Taipei, Taiwan, 12-17 May 2003., used only one exemplar trajectory derived from six repetitions of a similar reach-and-grasp operation, but to only one central workspace location. Given another grasp location, this original trajectory was adjusted toward the grasp location at each time step. In simulation, this method achieved a high placement accuracy, but for locations far from the original, the hand approached the wrench from the wrong direction for a grasp to be successful. When implemented on Robonaut, the Auto-Grasp method interacted poorly with the vision system. While it was possible to run one or two trials without a problem, the continual update of the wrench location would gradually introduce an error into the trajectory adjustment.

The second method, LinearGrasp, linearly interpolated the learned trajectories directly. First the distance in each Cartesian dimension from each of the nine example locations to the current wrench location was calculated. A Gaussian curve centered at each example provided weights for each dimension based on these distances. The weights were normalized and each example motion was multiplied by its corresponding weight. When these weighted motions were superpositioned, the result was a motion that would, ideally, perform the reach-and-grasp at the new location. Both in simulation and on Robonaut, however, the method was found to be imprecise. Sometimes it would grasp at the correct location; other times it would miss. A full description and analysis of both these programs and their results is available in Campbell, C. L., Learning through Teleoperation on Robonaut, M. S. Thesis, Vanderbilt University, December 2003, incorporated herein by reference.

The Verbs and Adverbs procedure was tested in simulation and on Robonaut. Simulation tests were run on a randomized list of 269 reachable targets in a 3D grid that covered the entire workspace and extended somewhat beyond the edges defined by the original box. The test on Robonaut was performed by affixing wrench to a jig, and arbitrarily picking reachable points in the workspace. Some attempt was made to cover the entire workspace, but since the goal was to prove that Robonaut could reach randomly generated targets, a systematic selection was not used. Robonaut's vision system was employed to locate the wrench in the workspace. A low pass filter was applied to the data stream to smooth the position information.

The major difficulty encountered in performing these experiments was Robonaut's eye-hand coordination. The actual location of the hand can vary as the encoders that measure the joint angles are turned on and off. At the time of the tests the solution to the problem was a manual calibration with three steps. First, the arm was reset (by eye) to its zero position and the encoders were reset so that they would report zero at that location. Second, the reported point-of-reference (POR) on Robonaut's hand was changed from the standard location for teleoperation, which is on the back the hand. That location on the robot corresponds to the location of the position sensor on the teleoperator's data glove. The POR was changed to the standard location for autonomous operation, which is in the middle of the palm. Third, a wrench was placed in the workspace and was reached for manually by moving the individual joints to the correct location, then the reference location for the hand was changed again by a few centimeters.

During the experiment, the wrench was put in 23 different locations. The runtime part of the Verbs and Adverbs program, which implements equation (38), was run for each of the locations. The only input that the program had were the results of the off-line analysis and the location of the wrench reported by the visual system, which was updated in real time.

The simulator was of limited value in testing the procedure since it had no direct method for judging the outcome of a grasp attempt. Nevertheless, the simulator was used since it enabled a more complete analysis of the workspace than with Robonaut, due to time-sharing constraints. To ameliorate the deficiencies of simulation, a numeric criteria was created from the trials run physically on Robonaut (both the original teleoperator examples and the experimental results). The trials were sorted based on physical evidence of a good or bad grasp, and then analyzed within the two categories. Three criteria for a good grasp in the simulated data were created. The first criterion was the most obvious. If the grasp occurred too far away from the wrench to have enveloped it, the grasp could not have been successful. Any grasp that was more than 2.6 cm from the wrench location was labeled as bad. The second and third criteria concern the approach angles. If the arm motion caused the hand to approach the wrench at the wrong angle, the hand could not grasp it because the fingers, or even the hand itself, would have had to physically pass through the wrench. To judge approach angles, a vector was created by finding the direction of motion produced in the final stages of the Reach behavior. When converted to spherical coordinates, this direction provided two approach angles: θ, measured in the x-y plane; and φ, the angle with respect to the z-axis. These angles provided a way to judge if the trial in simulation correctly approached the wrench. The data recorded from Robonaut determined that, for a successful approach, the angles had to be between −1.7° and −25.8° in φ and between 134.7° and 76.8° in θ.

Finally, some of the physical grasps that were incorrect were not the fault of the superposition method but of the calibration of the vision system (which was beyond the authors' control). Also, occasional inaccuracies in depth perception within various regions of the workspace resulted in errors in reported wrench location. When that happened, the hand grasped in front of, or behind the wrench. Nevertheless it did grasp at the location indicated. Since these errors were not in the superposition method itself, the corresponding grasps were defined as “marginal” and were classified as good grasps for the purpose of creating the simulator criteria and calculating results. This issue will be addressed further in future work.

Tables II and III report the results of the three methods in simulation and on Robonaut. The Verbs and Adverbs method clearly outperformed the other two programs. It had better than 99% accuracy in the simulator trials, which were designed to cover the entire workspace. While not performing perfectly in the physical trials, it outperformed other methods used for the task.

TABLE II
RESULTS FROM SIMULATION.

| Method | Good Angle | Good Dist. | Good Overall | % Good |
|---|---|---|---|---|
| AutoGrasp | 192 | 269 | 192 | 71.38 |
| LinearGrasp | 267 | 39 | 39 | 14.50 |
| VerbsAdverbs | 267 | 269 | 267 | 99.26 |

TABLE III
RESULTS FROM EXPERIMENTS ON ROBONAUT.

| Method | Good Grasps | Marginal Grasps | % Good or Marginal |
|---|---|---|---|
| AutoGrasp | 3 | 7 | 43.48 |
| LinearGrasp | 8 | 10 | 78.26 |
| VerbsAdverbs | 10 | 10 | 86.96 |

The work reported herein supports the hypothesis that a task can be learned by an articulated, dexterous robot through teleoperation, and that the task can be performed later autonomously with reasonable robustness. It was demonstrated that 45 repetitions of a reach-and-grasp task, 5 at each of 9 locations, was sufficient for autonomous performance at random locations throughout the workspace with a success rate of 87%. After teleoperation, sensory-motor data was segmented into episodes, and averaged to find 9 exemplar state-space trajectories. In the framework of the larger project that uses the results, the exemplars are nine instances of a sequence of 5 basic behaviors that were guided by 9 different sensory cues. The trajectories were interpolated successfully using the Verbs and Adverbs algorithm. This, in turn, supports the larger project's hypothesis that tasks learned as sequences of behaviors in the form of exemplars of clusters of sensory-motor state-space trajectories can be superpositioned to enable the robot to perform the task under more widely varying conditions than those during which the task was learned. That is, the runtime superpositioning of previously learned behaviors enables task robust task performance.

The next step in the project is to extend the types of behaviors used and demonstrate that behaviors learned at different times for different tasks can be composed at runtime to solve new problems. The present method bears some similarity to classical gain-scheduling; however, the dynamics of the under-lying Robonaut controllers did not dominate the behaviors we have explored so far. We plan to extend the range of behaviors to include highly dynamic ones and determine how well this procedure extends. Given a robust set of learned behaviors, we believe that their composition will allow Robonaut to become robust at problem-solving.

Appendix

In this appendix, we give the necessary formulae for updating motion on the SES. Since the formulae are necessary for actual implementation and use of the SES, they are included for completeness.

If the base frame of the robot remains fixed in space over time, any articulated motion of the robot can be counteracted via its known kinematics. Purely rotational motion of the base frame is easily compensated for by oppositely rotating the entire SES. That keeps the SES aligned with the environment while the robot the robot moves around within the SES. Translational motion of the base frame requires that object locations on the SES be shifted as a function of their distance from the base frame.

Such shifting of the information is prone to error. This error is not critical since the estimated SES location of an object serves as the starting point for a sensory search of the environment to locate the object more exactly. In this capacity, the SES provides reasonable starting locations for searches that should reduce the time necessary to track multiple objects.

As a robot moves, objects in its environment shift relatively. Thus, the projections of objects move on the Sensory Ego-Sphere. If the robot's motion is known, the change in SES projection can be estimated for any object a known distance away. If the distance to an object is unknown, motion on the SES permits the distance to be estimated. Reciprocally, concerted motion of a set of objects on the SES enable the robot to compute its motion relative to the objects. These estimation procedures also can alert the robot to independent motion by the object.

Calculations of the positions of objects with respect to the base frame are complicated by the motions of the objects, the motion of the base frame, and the articulated motions of the robot's appendages with respect to the base frame. Table IV exhibits the notation used to describe multiple positions with respect to multiple frames of reference at multiple times.

TABLE IV
NOTATION FOR COORDINATE TRANSFORMS.

| | |
|---|---|
| F₁^{B} | Coordinate frame B at time t |
| {\hat{x}ₜ^{B}, ŷₜ^{B}, \hat{z}ₜ^{B}} | Mutually orthogonal unit vectors that comprise Fₜ^{B} |
| pₜ | A specific point in space at time t |
| pₜ^{B} = [xₜ^{B} yₜ^{B} zₜ^{B}]^{T} | Rectangular coordinates of pₜ w.r.t. Fₜ^{B} |
| pₜ^{B} = [rₜ^{B} θₜ^{B} φₜ^{B}]^{T} | Spherical coordinates of pₜ w.r.t. Fₜ^{B} |
| (pₜ^{B})^{C} | pₜ w.r.t. Fₜ^{B} expressed w.r.t. Fₜ^{C} |
| T_{C,s}^{B,t} | Vector from Fₜ^{B} to F_{S}^{C} written w.r.t. Fₜ^{B} |
| T_{C,s}^{B,t} | Magnitude of T_{C,s}^{B,t} |
| A_{C,s}^{B,t} | Rotates Fₜ^{B} into alignment with Fₜ^{C} |
| A_{B,s}^{C,t} | Rotates coordinates w.r.t. Fₜ^{B} into coordinates |
| | w.r.t. Fₛ^{C} |
| Φ_{C}^{B}{•} | Transforms coordinates w.r.t. F^{C} into coordinates |
| | w.r.t. F^{B} |

Translation

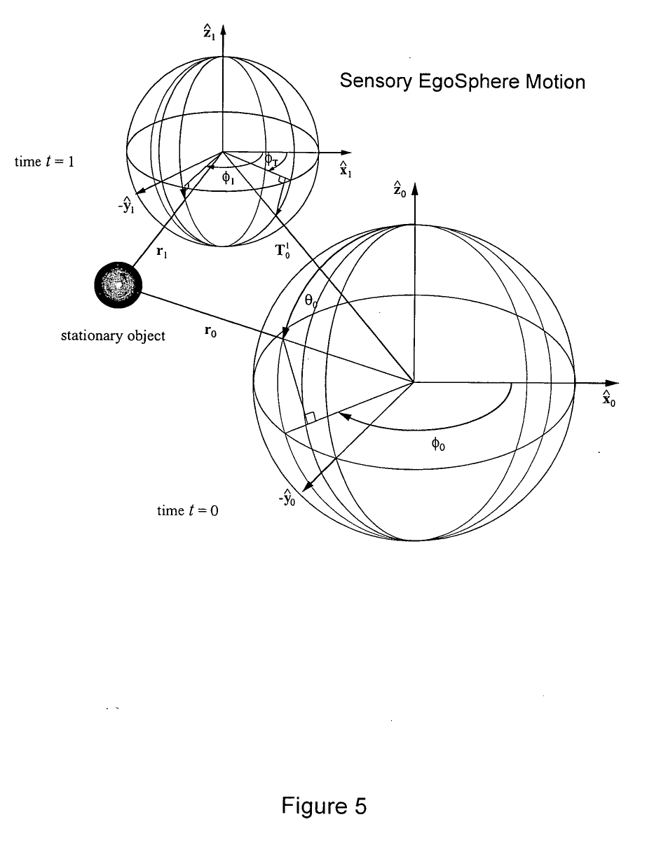

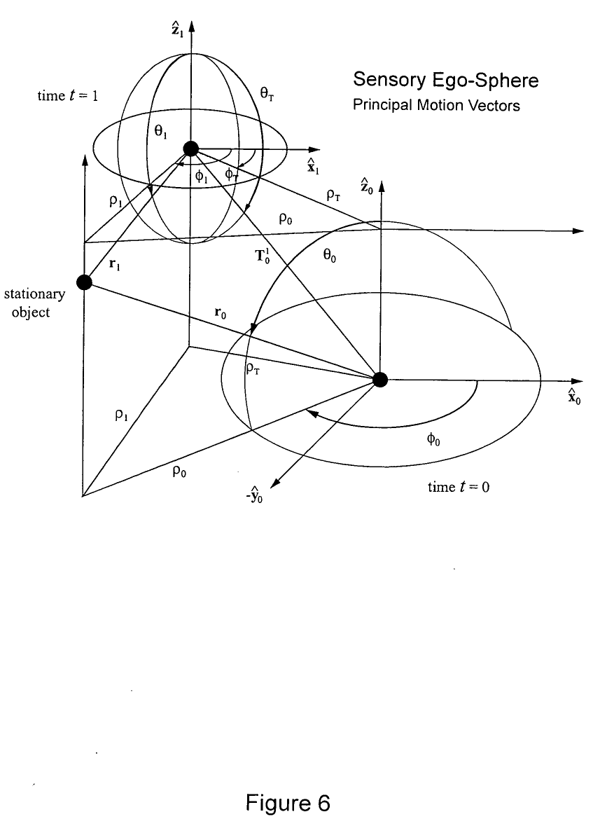

Consider the scenario of FIG. 5. The SES is depicted at two instants, t=0 and t=1 with base frames [symbol] ₀^{B} and [symbol] ₁^{B} A 3-D translation vector, T_{B,0}^{B,1}, connects the ego-centers. Since one base frame is translating over time, to simplify the notation we will write T₀¹ for T_{B,0}^{B,1}. A stationary object projects onto different locations at the two instants. Assume that the robot's directional sensors are all located at its base frame. We will relax this assumption in Section C. The object's projection vectors are r₀ and r₁ at times t=0 and t=1. FIG. 6 shows the planes in which the various vectors lie. Let the [symbol] ₜ^{B} ego-plane denote the plane spanned by \hat{x}ₜ^{B} and ŷₜ^{B}. The orthogonal projections of vectors T₀¹, r₀, and r₁ on the [symbol] ₀^{B} ego-plane are the vectors \vec{ρ}_{T}, \vec{ρ}₀, and \vec{ρ}₁. The computation of distance vectors r₀ and r₁ requires the SES translation direction, distance, and the angles to which the object projects before and after the translation. These form three vectors whose components are

$$[ \begin{matrix}{T}_{0}^{1} \\ {θ}_{T} \\ {ϕ}_{T}\end{matrix} ] , [ \begin{matrix}{r}_{0} \\ {θ}_{0} \\ {ϕ}_{0}\end{matrix} ] , [ \begin{matrix}{r}_{1} \\ {θ}_{1} \\ {ϕ}_{1}\end{matrix} ] . \qquad ( 39 )$$

Assume that we know (θ₀, φ₀), the SES projection of the object prior to moving known distance and direction [T₀¹ θ_{T} φ_{T}]^{T} and that we know, (θ₁, φ₁), the object's projection after the move. To find the (scalar) distances r₁ and r₀ start with the vector components in the ego-plane of the t=0 configuration. The geometry yields the (scalar) values

$$\begin{matrix}{ρ}_{1} = \frac{{ρ}_{T} sin ( {ϕ}_{T} - {ϕ}_{0} )}{sin ( {ϕ}_{1} - {ϕ}_{0} )} and & ( 40 ) \\ {ρ}_{0} = \frac{{ρ}_{T} sin ( {ϕ}_{1} - {ϕ}_{T} )}{sin ( {ϕ}_{0} - {ϕ}_{1} )} where & ( 41 ) \\ \begin{matrix} {ρ}_{1} = {r}_{1} sin {θ}_{1} \\ {ρ}_{0} = {r}_{0} sin {θ}_{0} and \\ {ρ}_{T} = {r}_{T} sin {θ}_{T}\end{matrix} \\ Therefore , & ( 42 ) \\ {r}_{1} = {T}_{0}^{1} \frac{sin {θ}_{T} sin ( {ϕ}_{T} - {ϕ}_{0} )}{sin {θ}_{1} sin ( {ϕ}_{1} - {ϕ}_{0} )} and & ( 43 ) \\ {r}_{0} = {T}_{0}^{1} \frac{sin {θ}_{T} sin ( {ϕ}_{1} - {ϕ}_{T} )}{sin {θ}_{0} sin ( {ϕ}_{0} - {ϕ}_{1} )} & ( 44 )\end{matrix}$$

Since (θₛ, φₛ) are known for s=0, 1, T the vectors r₀ and r₁ are specified.

Now assume that r₀=(r₀, θ₀, φ₀) and T₀¹=(T₀¹, θ_{T}, φ_{T}) are known, and that the ego-sphere projection, (θ₁, φ₁), of the object after the motion is to be estimated. Vector r₁=r₀−T₀¹. From r₁, we can estimate the angles. To compute them, convert r₀ and T₀¹ to rectangular components. Then r₁=[x₁ y₁ z₁]^{T} where
x₁=ρ₀ cos φ₀−ρ_{T} COS φ_{T}
y₁=ρ₀ sin φ₀−ρ_{T} sin φ_{T}
z₁=r₀ cos θ₀−T₀¹ COS θ_{T} (45)
Values ρ₀ and ρ_{T} are as in (8). Then

$$\begin{matrix}{ϕ}_{1} = {tan}^{- 1} ( \frac{{y}_{1}}{{x}_{1}} ) , and & ( 46 ) \\ {θ}_{1} = {tan}^{- 1} ( \frac{{z}_{1}}{{ρ}_{1}} ) , where & ( 47 ) \\ {ρ}_{1} = \sqrt{{x}_{1}^{2} + {y}_{1}^{2}} = \sqrt{{ρ}_{0}^{2} - 2 {ρ}_{0} {ρ}_{T} cos ( {ϕ}_{0} - {ϕ}_{T} ) + {ρ}_{T}^{2}} & ( 48 )\end{matrix}$$

Translation with Rotation

The most general case of ego-sphere motion is a translation by [T₀¹ θ_{T} φ_{T}]^{T} followed by a rotation (θ_{A}, φ_{A}) of the axes. To compute r₁ use equation (43) replacing θ₁ with θ₁+θ_{A} and φ₁ with φ₁+φ_{A}. That is,

$${r}_{1} = {T}_{0}^{2} \frac{sin {θ}_{T} sin ( {ϕ}_{T} - {ϕ}_{0} )}{sin ( {θ}_{1} + {θ}_{A} ) sin ( {ϕ}_{1} + {ϕ}_{A} - {ϕ}_{0} )} \qquad ( 49 )$$

If the intersection angles (θ₁, φ₁) are to be computed use equations (45) through (48) and subtract θ_{A} and φ_{A} from the results.

$$\begin{matrix}{ϕ}_{1} = {tan}^{- 1} ( \frac{{y}_{1}}{{x}_{1}} ) - {ϕ}_{A} , and & ( 50 ) \\ {θ}_{1} = {tan}^{- 1} ( \frac{{z}_{1}}{{ρ}_{1}} ) - {θ}_{A} . & ( 51 )\end{matrix}$$

Equations (45) and (48) are used exactly as written (θ_{A} and φ_{A} are not substituted into them).

If an object can be located on the SES at successive times, then equation (49) can be used to estimate its distance from the base frame. (This equation is nothing more than motion stereopsis and is, therefore, subject to the same errors and noise sensitivity as fixed baseline stereopsis but is compounded by the errors in estimating the actual motion of the base frame.) Sometimes the distance to an object point will be known through stereo vision or other range finding techniques. Then motion equations (50) and (51) are useful to restrict the search for the same object at a later time. But, note that once the object is located, its position can be used to estimate its distance. Thus, motion leads to a reciprocal process of using an object's projection on the SES over time to estimate its distance and using that estimate to constrain the projection search space. As the robot moves, more estimates can be made. All these measurements can be combined to improve the reliability of the estimated distance.

Articulated Motion with Respect to a Fixed Base-Frame

An articulated robot such as a humanoid has appendages and end-effectors that move with respect to its base frame. The proprioception of dynamic body configuration is a spatially distributed sensory process that is a function of the robot kinematics. The physical contact of the robot's body with a surface can elicit a simultaneous response from its various sensors (e.g., force, torque, strain, tactile). The sensory events that result from either source can be registered by projecting the instantaneous locations of the sensors and the joints onto the SES. The projection is straightforward: the position pₜ^{s} with respect to the base frame of a given sensor is written in spherical coordinates as

$${p}_{t}^{S} = [ \begin{matrix}{r}_{t}^{S} \\ {θ}_{t}^{S} \\ {ϕ}_{t}^{S}\end{matrix} ] . \qquad ( 52 )$$

Distance rₜ^{s} is written at SES location (θ^{S},φ^{S}) with a time stamp of t. Whereas sensory events that occur on the robot's body are easily projected to the SES through its kinematics, remote events detected by a directional sensor, such as camera platform are more difficult (see FIG. 3).

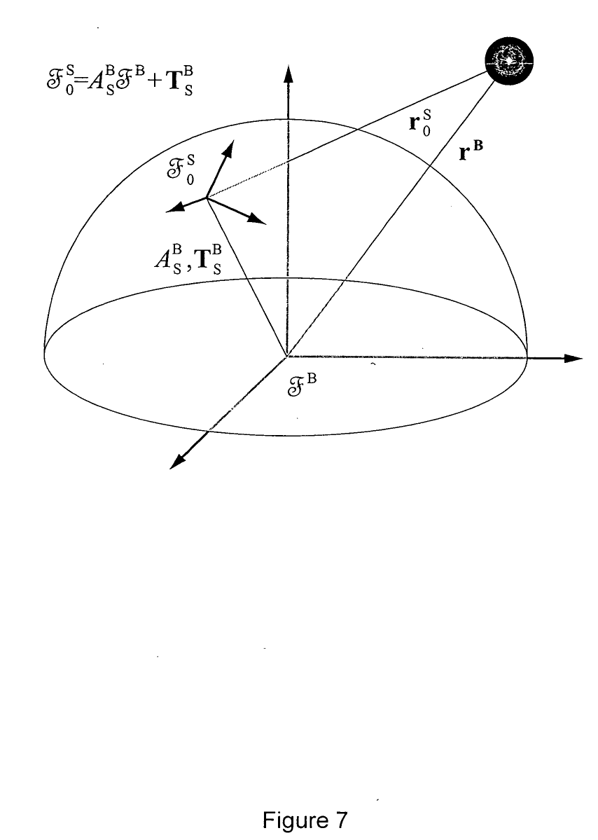

Consider a stationary object imaged at time t=O by a camera head whose frame, [symbol] ₀^{S}, is rotated by A_{S}^{B} with respect to the base frame, [symbol] ^{B}, and displaced from it by T_{S}^{B} (see FIG. 7).

If the displacement, r₀^{S}, of an object point from the camera frame is known, then the coordinates of that point with respect to the base frame are given by
r₀^{B}=Φ_{S}^{B}{r₀^{S}}=A_{S}^{B}r₀^{S}+T_{S}^{B} (53)
However, as is often the case, if the distance from the camera head to the object is unknown then all that is known is that the object lies on the ray

$${ℓ}^{S} ( {r}^{S} ) = [ \begin{matrix}{r}^{S} \\ {θ}_{0}^{S} \\ {ϕ}_{0}^{S}\end{matrix} ] , \qquad ( 54 )$$

from the camera frame in direction (θ₀^{S}, φ₀^{S}). Scalar, r^{S}, is the distance along the ray from the origin of camera frame.

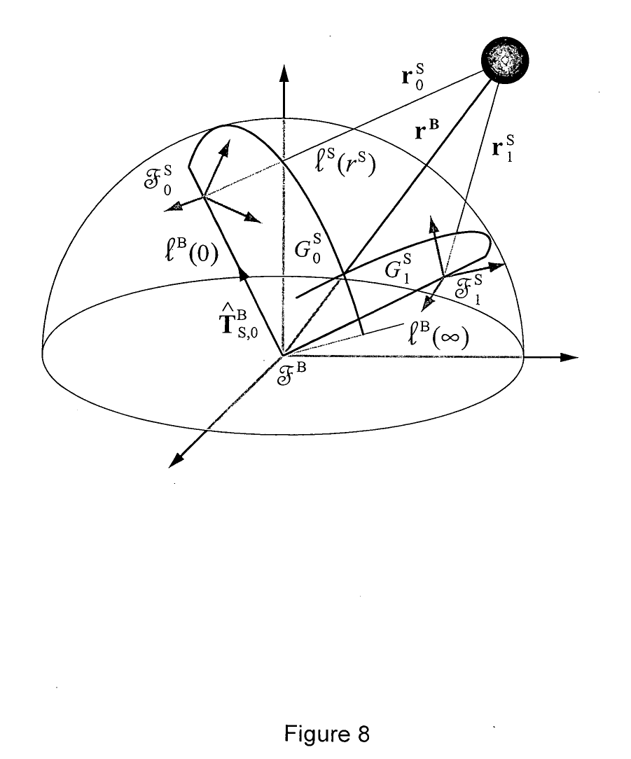

Let r^{S}=[r^{S} θ₀^{S} φ₀^{S}] be any point on ray l^{S} written as a vector with respect to the camera frame, [symbol] ₀^{S}. Vector r^{B}, the location of r^{S} with respect to the base frame, is given by equation (53). Let l^{B}(r₀^{S}) be the line segment from the origin of the base frame to the point on l^{S} a distance r^{S} from the origin of the camera frame. If we let r^{S} vary from 0 to ∞, then l^{B}(r₀^{s}) traces an arc of a great circle on the SES (see FIG. 8). The arc extends from the intersection of the SES with the ray through \hat{T}^{B}_{S,0} (the unit vector at [symbol] ^{B} in the direction of [symbol] ₀^{S}) to the intersection of the SES with the ray from the origin of [symbol] ^{B} with direction (θ₀^{S}, φ₀^{S}) (i.e., the ray from [symbol] ^{B} parallel to l^{S}.)

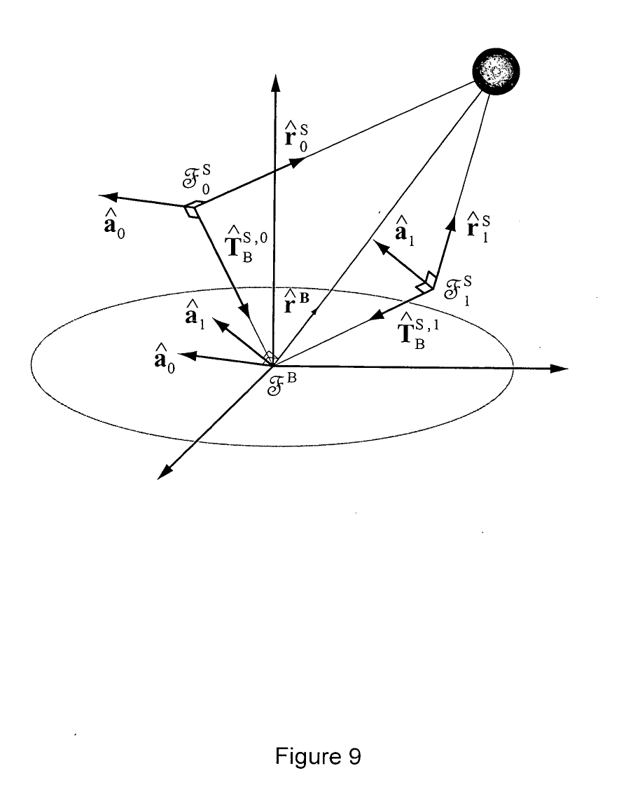

To find the direction to the object from the base frame when the distance to the object is unknown, either a second camera must image it, or the first camera must be moved to a second position that is not in the plane of r₀^{S} and \hat{T}^{B}_{S,0}. The ray from the second camera in the direction of the object projects to an arc on a second great circle on the SES. The projection of the object on the SES is at the point of intersection of the two arcs. In fact, to compute the direction of the object with respect to the base frame, it is not necessary to compute the great circles and to find their point of intersection (see FIG. 9). A great circle is defined as the intersection of a spherical surface with a plane through its center. The arc traced by camera 0 is defined by the plane that contains unit vectors \hat{r}₀^{S} and \hat{T}_{B}^{S,0}. Similarly, the arc traced by camera 1 is the intersection of the plane containing unit vectors \hat{r}₁^{S} and \hat{T}_{B}^{S,1}. Ray l^{B}(r₀^{s}) from the origin of the base frame in the direction of the object is the intersection of these two planes.

Now, the vector cross product
â₀\hat{r}₀^{S}×\hat{T}_{B}^{S,0}, (55)
is perpendicular to the first plane and
â₁=\hat{r}₁^{S}×\hat{T}_{B}^{S,1}, (56)
is perpendicular to the second. Thus l^{B}(r₀^{s}) is perpendicular to both â₀ and â₁. Therefore \hat{r}^{B}, the unit vector at the base frame in the direction of the object, is given by
\hat{r}^{B}=â₀×â₁. (57)

1. An interface for a robot that serves to mediate information between sensors and cognition, comprising:
means for supporting spatio-temporal sensory-motor event detection;
means for supporting localized short-term memory; and
means for supporting ego-centric navigation.
